(19) United States
(12) Patent Application Publication
(10) Pub. No.: US 2008/0209467 A1
(43) Pub. Date: Aug. 28, 2008

(54) BROADCAST SIGNAL PROCESSING APPARATUS AND CONTROL METHOD THEREOF

(75) Inventor: Min-suk SONG, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/953,898

(22) Filed: Dec. 11, 2007

(30) Foreign Application Priority Data
Feb. 26, 2007 (KR) 10-2007-0019074

(51) Int. Cl. H04N 7/10

(52) U.S. Cl. 725/34

(57) ABSTRACT

A broadcast signal processing apparatus, includes: a signal processor which processes a broadcast signal of a broadcast program to display an image corresponding to the broadcast program, an information receiver which receives source data having predetermined broadcast information on the broadcast program, an information storage unit which stores at least one extraction information to extract the broadcast information included in the source data and a controller which extracts the broadcast information included in the source data based on one of the at least one extraction information stored in the information storage unit corresponding to a format of the broadcast information included in the source data received by the information receiver.

### CROSS-REFERENCE TO RELATED APPLICATIONS

This application claims priority from Korean Patent Application No. 10-2007-0019074, filed on Feb. 26, 2007, in the Korean Intellectual Property Office, the disclosure of which is incorporated herein by reference.

### BACKGROUND OF THE INVENTION

1. Field of the Invention

Apparatuses and methods consistent with the present invention relate to broadcast signal processing, and more particularly, to a broadcast signal processing apparatus which receives broadcast information and processes a broadcast signal by using received broadcast information, and a control method thereof.

2. Description of the Related Art

A broadcast signal processing apparatus such as a TV or a set-top box receives a broadcast signal including broadcast programs from a broadcasting station, and processes the received broadcast signal to display an image corresponding to the broadcast programs.

Various broadcast programs may be carried on and broadcast through the broadcast signals. That is, the broadcast signal may include a plurality of channels, and a broadcast signal processing apparatus may receive a broadcast program corresponding to one of the plurality of channels. Also, a single channel may provide various broadcast programs according to time.

Thus, the broadcast signal processing apparatus is required to receive information on channels, air time and content of the broadcast program (hereinafter, to be called broadcast information) in advance and supply the received broadcast information to a user so that a user can view a desired broadcast program.

A process of receiving such broadcast information in a related art broadcast signal processing apparatus is as follows. For example, a broadcasting station which broadcasts the broadcast program of the selected channel may supply broadcast information on a specific channel. In this case, the broadcast signal processing apparatus may receive the broadcast information of the channel while receiving the broadcast signal of the channel. However, broadcast information on other channels cannot be obtained in this case.

According to another related art process, broadcast information on various channels may be supplied without limitation to the specific channel. For example, there can be a broadcasting station which specializes in supplying broadcast information only, or a web server which supplies broadcast information through a network such as Internet.

In this case, broadcast information on various channels are supplied. However, such service can be limited to some users, and generate service expenses.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Accordingly, it is an aspect of the present invention to provide a broadcast signal processing apparatus which receives broadcast information on various channels without additional costs, and a control method thereof.

Additional aspects and/or advantages of the present invention will be set forth in part in the description which follows and, in part, will be obvious from the description, or may be learned by practice of the present invention.

According to an aspect of the present invention there is provided a broadcast signal processing apparatus, including: a signal processor which processes a broadcast signal of a broadcast program to display an image corresponding to the broadcast program; an information receiver which receives source data having predetermined broadcast information on the broadcast program; an information storage unit which stores at least one extraction information to extract the broadcast information included in the source data; and a controller which extracts the broadcast information included in the source data based on one of the at least one extraction information stored in the information storage unit corresponding to a format of the broadcast information included in the source data received by the information receiver.

According to an aspect of the present invention, the source data includes a first web address and the controller selects one of the at least one extraction information corresponding to the first web address of the source data received by the information receiver.

According to an aspect of the present invention, the broadcast signal processing apparatus further includes a user input unit which receives the first web address, wherein the controller controls the information receiver to receive the source data corresponding to the first web address input by the user input unit.

According to an aspect of the present invention, the information storage unit stores at least one second web address therein, and the first web address is input in a manner that one of at least one second web address stored in the information storage unit is selected through the user input unit and the first web address corresponds to the selected second web address.

According to an aspect of the present invention, the information receiver receives the extraction information from an external device to be stored in the information storage unit.

According to an aspect of the present invention, the broadcast signal processing apparatus further includes a graphical user interface (GUI) generator which generates a GUI to display the broadcast information extracted from the source data.

According to an aspect of the present invention, the broadcast information includes at least one of a channel, air time and content of the broadcast program, and the controller controls the GUI generator to arrange the information on the channel, the air time and the content to correspond to each other in the GUI.

According to an aspect of the present invention, the broadcast signal processing apparatus further includes a display unit which displays the GUI generated by the GUI generator.

According to an aspect of the present invention, the signal processor includes a broadcast signal receiver which receives the broadcast signal corresponding to one of a plurality of channels on the broadcast program, the information storage unit stores reception channel information on at least one of the plurality of channels of the broadcast signal received by the broadcast signal receiver, the broadcast information extracted from the source data includes extraction channel information on the channel, and the controller maps between the extraction channel information and the reception channel information, and controls the broadcast signal receiver to receive the broadcast signal of the corresponding channel if the valid extraction channel information is selected based on the mapping result.

According to an aspect of the present invention, the controller determines the reception channel information corresponding to the extraction channel information according to a user's input if the reception channel information equivalent to the extraction channel information does not exist in the reception channel information stored in the information storage unit.

According to an aspect of the present invention, the information receiver receives the source data by Bluetooth communication method through an information transmitting apparatus.

According to another aspect of the present invention there is provided a method of controlling a broadcast signal processing apparatus which processes a broadcast signal of a broadcast program to display an image corresponding to the broadcast program, the method including: receiving source data including predetermined broadcast information on the broadcast program; determining extraction information corresponding to a format of the broadcast information included in the received source data among at least one extraction information to extract the broadcast information included in the source data; and extracting the broadcast information included in the source data based on the determined extraction information.

According to an aspect of the present invention, the source data includes a first web address, and the determining the extraction information includes determining the extraction information corresponding to the first web address of the received source data, among at least one extraction information.

According to an aspect of the present invention, the method further includes receiving the first web address, wherein the receiving the source data includes receiving the source data corresponding to the first web address.

According to an aspect of the present invention, the method further includes storing at least one second web address, wherein the receiving the web address includes selecting one of the at least one second web address and the selected web address corresponds to the first web address.

According to an aspect of the present invention, the determining the extraction information includes receiving the at least one extraction information from an external device.

According to an aspect of the present invention, the method further includes generating a graphical user interface (GUI) to display the broadcast information extracted from the source data.

According to an aspect of the present invention, the broadcast information includes at least one of a channel, air time and content of the broadcast program, and the generating the GUI includes arranging the information on the channel, the air time and the content of the broadcast program to correspond to each other in the GUI.

According to an aspect of the present invention, the method further includes displaying the generated GUI.

According to an aspect of the present invention, the broadcast information extracted from the source data includes extraction channel information on the channel, the method further including: mapping between the extraction channel information and reception channel information on at least one channel of the received broadcast signal, and receiving the broadcast signal of the corresponding channel if the valid extraction channel information is selected based on the mapping result.

According to an aspect of the present invention, the mapping between the extraction channel information and the reception channel information includes determining the reception channel information corresponding to the extraction channel information by a user's input if the reception channel information equivalent to the extraction channel information does not exist.

According to an aspect of the present invention, the receiving the source data includes receiving the source data by Bluetooth communication method.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a block diagram of a broadcast signal processing apparatus according to an exemplary embodiment of the present invention;

FIG. 2 is a diagram illustrating a web page as source data according to the exemplary embodiment of the present invention;

FIG. 3 is a flowchart illustrating a control method of the broadcast signal processing apparatus according to the exemplary embodiment of the present invention;

FIG. 4 is a flowchart illustrating a process of mapping between reception channel information and extraction channel information according to the exemplary embodiment of the present invention; and

FIG. 5 is a block diagram of a broadcast signal processing apparatus according to another exemplary embodiment of the present invention.

### DETAILED DESCRIPTION OF EXEMPLARY EMBODIMENTS

Hereinafter, exemplary embodiments of the present invention will be described with reference to accompanying drawings, wherein like numerals refer to like elements and repetitive descriptions will be avoided as necessary.

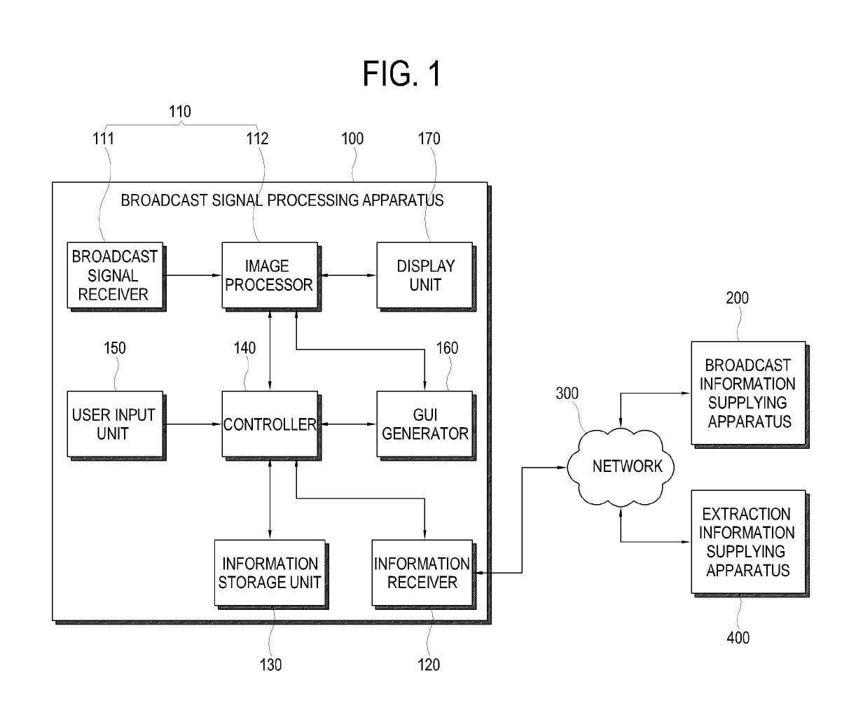

FIG. 1 is a block diagram of a broadcast signal processing apparatus 100 according to an exemplary embodiment of the present invention. The broadcast signal processing apparatus 100 may include a TV or a set-top box. The broadcast signal processing apparatus 100 receives a broadcast signal including broadcast programs from a broadcasting station (not shown), and processes the received broadcast signal to display an image corresponding to the broadcast programs.

The broadcast signal supplied to the broadcast signal processing apparatus 100 may include a plurality of channels, and the broadcast signal processing apparatus 100 may receive a broadcast program of one of the plurality of channels. Also, various broadcast programs may be supplied through broadcast signals of respective channels according to time.

As shown in FIG. 1, the broadcast signal processing apparatus 100 includes a signal processor 110, an information receiver 120, an information storage unit 130, and a controller 140.

The signal processor 110 processes a broadcast signal of a broadcast program to display an image of the broadcast program. The signal processor 110 may include a broadcast signal receiver 111 and an image processor 112.

The broadcast signal receiver 111 receives a broadcast signal corresponding to a channel selected among the plurality of channels. The broadcast signal receiver 111 tunes a predetermined frequency corresponding to the selected channel under a control of the controller 140. The broadcast signal supplied to the broadcast signal receiver 111 includes analog and digital broadcast signals.

The image processor 112 performs image processing for the received broadcast signal to display an image based on the broadcast program included in the broadcast signal received by the broadcast signal receiver 111. The image processing of the image processor 112 may include analog to digital conversion, decoding, scaling and other known image processing in the art.

The information receiver 120 receives source data having predetermined broadcast information on a broadcast program. The information receiver 120 may receive the source data from a broadcast information supplying apparatus 200 which supplies the broadcast information. The broadcast information supplying apparatus 200 may include a web server. The information receiver 120 may communicate with the broadcast information supplying apparatus 200 through a network 300 such as Internet to receive the source data. The information receiver 120 may communicate with the broadcast information supplying apparatus 200 according to Internet Protocol (IP).

The source data supplied to the information receiver 120 may include a web page which has a predetermined web address or a Universal Resource Locator. The web page may include a HyperText Markup Language (HTML). The information receiver 120 may receive the source data from the broadcast information supplying apparatus 200 according to HyperText Transfer Protocol (HTTP).

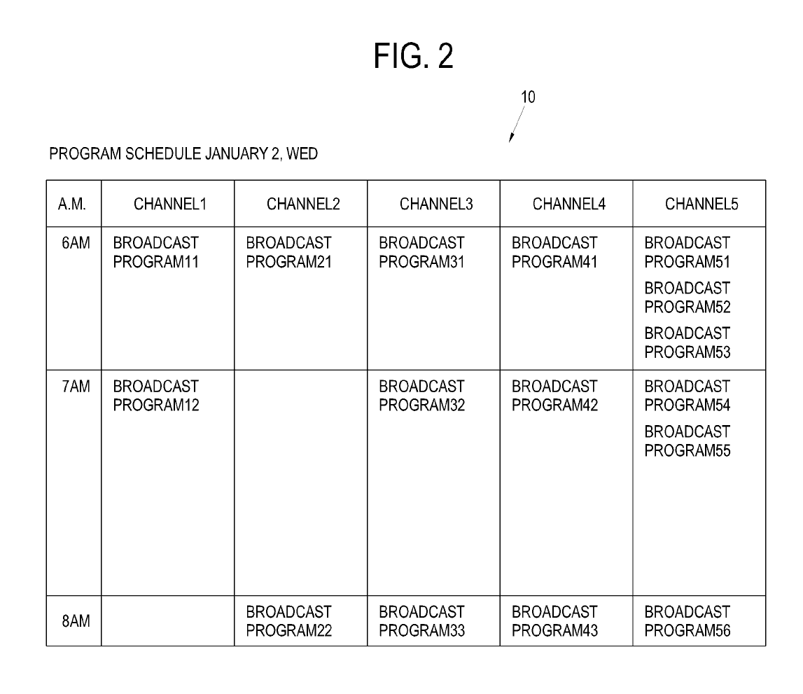

The broadcast information included in the source data may include information on channels, air time, content, etc. of the broadcast program to be included in the broadcast signal supplied to the broadcast signal receiver 111. FIG. 2 illustrates a web page 10 as the source data according to the exemplary embodiment of the present invention. As shown therein, the broadcast information included in the web page 10 may include channel information such as channel 1 and channel 2, time information such as 6 a.m. and 7 a.m., and content information such as broadcast program 1, broadcast program 2, etc.

The source data includes the broadcast information in a predetermined format. For example, if the source data includes a HTML file, the broadcast information may include a text corresponding to channel 1, 6 a.m. and broadcast program 1, and a label on the text. The label format may be provided in various ways.

The information storage unit 130 stores at least one extraction information to extract the broadcast information included in the source data. The extraction information stored in the information storage unit 130 may include information on the storage format of the broadcast information included in the source data. As the broadcast information may be variously included in the source data depending on the broadcast information supplying apparatus 200, the broadcast signal processing apparatus 100 requires extraction information corresponding to the format of the broadcast information to extract the broadcast information included in the source data.

For example, if the source data includes a HTML file, the extraction information shows the way in which the text and the label are configured. That is, there can be obtained such information as whether the text included in the source data corresponds to a channel or to air time.

The controller 140 extracts the broadcast information included in the source data based on one extraction information corresponding to the format of the broadcast information included in the source data received by the information receiver 120, among at least one extraction information stored in the information storage unit 130.

The controller 140 may select one of the extraction information stored in the information storage unit 130 that corresponds to the web address of the web page of the source data received by the information receiver 120, as the extraction information corresponds to the format of the broadcast information included in the source data received by the information receiver 120. That is, the information storage unit 130 stores respective extraction information corresponding to the web address. The controller 140 may determine the corresponding extraction information by checking the web address of the web page of the received source data.

The extraction information which is stored in the information storage unit 130 may be received from the outside through the information receiver 120. For example, the controller 140 may receive the extraction information from the outside if the extraction information corresponding to a desired web page is not stored in the information storage unit 130, or if a version of the extraction information corresponding to the desired web page is out of date.

Then, the information receiver 120 may receive the extraction information from an extraction information supplying apparatus 400 according to a control of the controller 140. The extraction information supplying apparatus 400 may include a web server.

As shown in FIG. 1, the broadcast signal processing apparatus 100 may further include a user input unit 150 which receives a web address from a user. In this case, the controller 140 may control the information receiver 120 to receive the source data having the web address input through the user input unit 150. The user input unit 150 may include a remote controller or a control panel. Thus, the broadcast information which is supplied as a web page of the web site known to a user, may be provided through the broadcast signal processing apparatus 100.

The information storage unit 130 may store at least one web address therein. For example, the controller 140 may store a web address of the source data received by the information receiver 120 in the information storage unit 130.

The controller 140 may control the information receiver 150 to select one of at least one web address stored in the information storage unit 130 according to a user's input through the user input unit 150 and receive the source data corresponding to the selected web address. That is, the controller 140 may store the web address of the web page input by a user in the information storage unit 130, and allow the user to select one of the stored web addresses to receive the broadcast information, thereby improving user's convenience.

As shown in FIG. 1, the broadcast signal processing apparatus 100 may further include a graphical user interface (GUI) generator 160 which generates a graphical user interface (GUI) (not shown) to display the broadcast information extracted from the source data. The controller 140 may control the GUI generator 160 to arrange information on the channels, air time and content to correspond to each other in the GUI. For example, the information on the channels, air time and content shown in the GUI may be arranged similarly to the broadcast information of the web page 10 in FIG. 2.

As shown in FIG. 1, the broadcast signal processing apparatus 100 may further include a display unit 170 which displays the GUI generated by the GUI generator 160. The display unit 170 which displays the GUI may include a cathode ray tube (CRT), a liquid crystal display (LCD), a plasma display panel (PDP), a projection type display, and other known display units in the art. If the broadcast signal processing apparatus 100 includes a set-top box, the display unit 170 may be omitted.

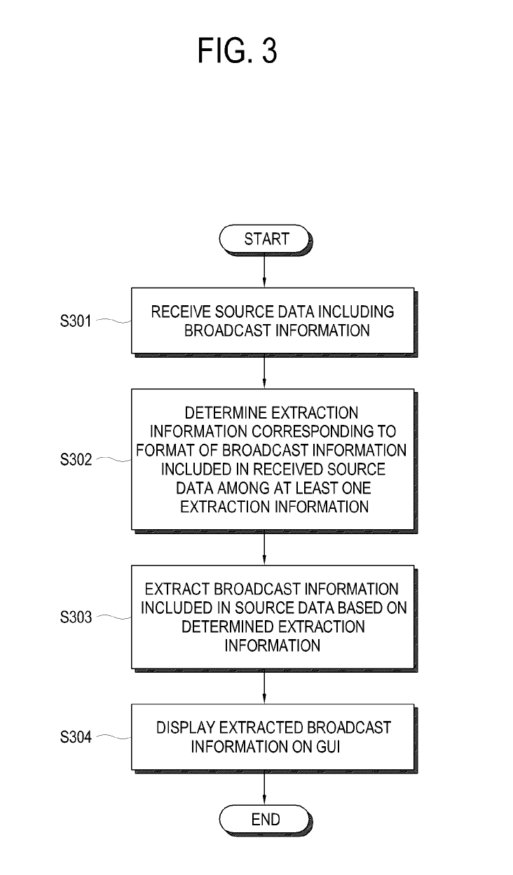

FIG. 3 is a flowchart which illustrates a control method of the broadcast signal processing apparatus 100 according to the exemplary embodiment of the present invention. First, the controller 140 controls the signal processor 110 to receive the source data including predetermined broadcast information on the broadcast program (S301).

Then, the controller 140 determines one of the extraction information corresponding to the format of the broadcast information included in the source data to extract the broadcast information included in the source data (S302).

The controller 140 extracts the broadcast information included in the source data based on the determined extraction information (S303).

According to another exemplary embodiment of the present invention, the controller 140 may control the GUI generator 160 to display the extracted broadcast information on the GUI (S304).

The information storage unit 130 in FIG. 1 may store information on at least one channel (hereinafter, to be called reception channel information) of the broadcast signals received by the broadcast signal receiver 111. The reception channel information may include a channel number of a channel which is receivable by the broadcast signal processing apparatus 100.

The controller 140 may map between the pre-stored reception channel information and channel information included in the extracted broadcast information (hereinafter, to be called extraction channel information) to receive a corresponding channel if a valid extraction channel information is selected later. The extraction channel information may be selected from the GUI, thereby using the extracted broadcast information more effectively.

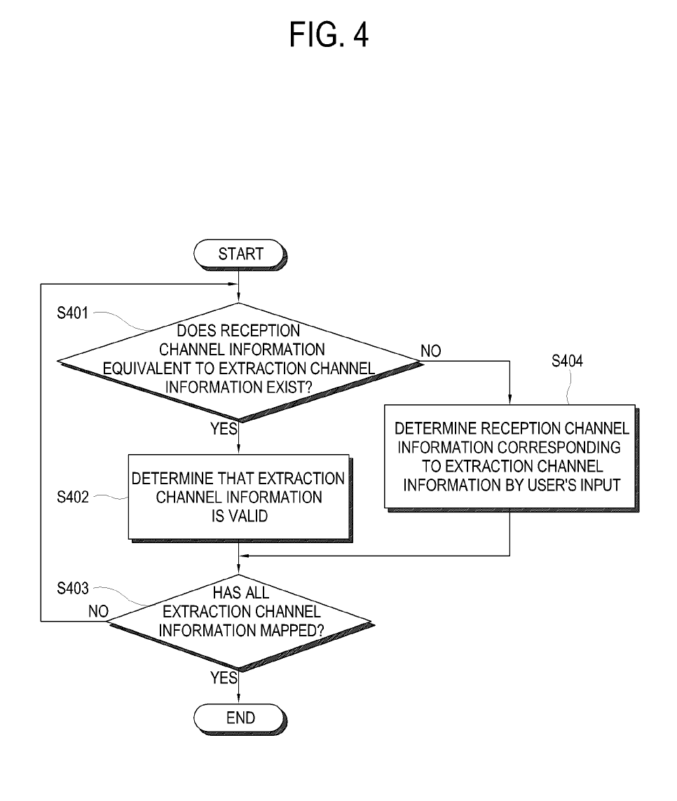

FIG. 4 is a flowchart which illustrates a mapping process between the reception channel information and the extraction channel information according to the exemplary embodiment of the present invention. First, the controller 140 determines whether the reception channel information equivalent to the extraction channel information exists in the stored reception channel information (S401).

If it is determined at operation S401 that the reception channel information equivalent to the extraction channel information exists in the stored reception channel information, the controller 140 determines that the extraction channel information is valid (S402). The controller 140 determines whether the overall extraction channel information has been mapped (S403), and performs the operation S401 for the subsequent extraction channel information if the mapping process has not been completed.

If it is determined at operation S401 that the reception channel information equivalent to the extraction channel information does not exist in the stored reception channel information, the controller 140 determines the reception channel information corresponding to the extraction channel information according to a user's input (S404).

For example, the controller 140 may sequentially display images of the plurality of channels, and a user may select one of the plurality of extraction channel information while the images are displayed at operation S404. In this case, the controller 140 may determine the reception channel information of the channel that is displayed during a user's selection, as the reception channel information corresponding to the selected extraction channel information. The selected broadcast information may be stored in the information storage unit 130.

If operation S404 is finished, operation S403 is performed. If it is determined at operation S403 that the overall extraction channel information has been completely mapped, the mapping process is finished.

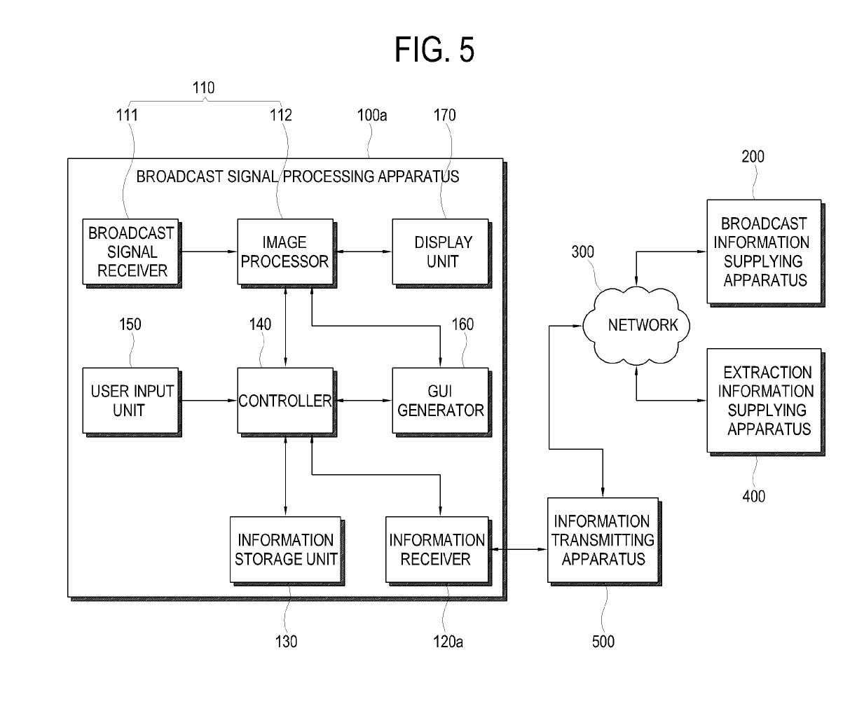

FIG. 5 is a block diagram of a broadcast signal processing apparatus 100a according to another exemplary embodiment of the present invention. The broadcast signal processing apparatus 100a includes elements which are equivalent or similar to those of the broadcast signal processing apparatus 100 in FIG. 1, except an information transmitting apparatus 500. As shown in FIG. 5, the information receiver 120a receives source data by Bluetooth communication method through an information transmitting apparatus 500. The information transmitting apparatus 500 may include a Bluetooth device which communicates with the broadcast information supplying apparatus 200 through a network 300.

According to another exemplary embodiment of the present invention, the broadcast signal processing apparatus 100a may receive source data according to other wireless communication methods instead of Bluetooth. Other wireless communication methods include wireless personal area network (WPAN), wireless local area network (WLAN), and other known wireless communication methods in the art. According to another exemplary embodiment of the present invention, the broadcast signal processing apparatus 100a may receive source data through a wired communication method such as a universal serial bus (USB), as well as wireless communication methods.

As described above, the present invention provides a broadcast signal processing apparatus which receives broadcast information on various channels without additional costs, and a control method thereof.

Also, the present invention provides a broadcast signal processing apparatus which uses broadcast information more effectively, and a control method thereof

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A broadcast signal processing apparatus, comprising:
a signal processor which processes a broadcast signal of a broadcast program to display an image corresponding to the broadcast program;
an information receiver which receives source data having predetermined broadcast information on the broadcast program;
an information storage unit which stores at least one extraction information to extract the broadcast information included in the source data; and
a controller which extracts the broadcast information included in the source data based on one of the at least one extraction information stored in the information storage unit corresponding to a format of the broadcast information included in the source data received by the information receiver.

2. The broadcast signal processing apparatus according to claim 1, wherein the source data comprises a first web address and the controller selects one of the at least one extraction information corresponding to the first web address of the source data received by the information receiver.

3. The broadcast signal processing apparatus according to claim 2, further comprising a user input unit which receives the first web address, wherein
the controller controls the information receiver to receive the source data corresponding to the first web address input by the user input unit.

4. The broadcast signal processing apparatus according to claim 3, wherein the information storage unit stores at least one second web address therein, and the first web address is input in a manner that one of at least one second web address stored in the information storage unit is selected through the user input unit and the first web address corresponds to the selected second web address.

5. The broadcast signal processing apparatus according to claim 1, wherein the information receiver receives the extraction information from an external device to be stored in the information storage unit.

6. The broadcast signal processing apparatus according to claim 1, further comprising a graphical user interface (GUI) generator which generates a GUI to display the broadcast information extracted from the source data.

7. The broadcast signal processing apparatus according to claim 6, wherein the broadcast information comprises at least one of a channel, air time and content of the broadcast program, and the controller controls the GUI generator to arrange the information on the channel, the air time and the content to correspond to each other in the GUI.

8. The broadcast signal processing apparatus according to claim 6, further comprising a display unit which displays the GUI generated by the GUI generator.

9. The broadcast signal processing apparatus according to claim 1, wherein
the signal processor comprises a broadcast signal receiver which receives the broadcast signal corresponding to one of a plurality of channels on the broadcast program,
the information storage unit stores reception channel information on at least one of the plurality of channels of the broadcast signal received by the broadcast signal receiver,
the broadcast information extracted from the source data comprises extraction channel information on the channel, and
the controller maps between the extraction channel information and the reception channel information, and controls the broadcast signal receiver to receive the broadcast signal of the corresponding channel if the valid extraction channel information is selected based on the mapping result.

10. The broadcast signal processing apparatus according to claim 9, wherein the controller determines the reception channel information corresponding to the extraction channel information according to a user's input if the reception channel information equivalent to the extraction channel information does not exist in the reception channel information stored in the information storage unit.

11. The broadcast signal processing apparatus according to claim 1, wherein the information receiver receives the source data by Bluetooth communication method through an information transmitting apparatus.

12. A method of controlling a broadcast signal processing apparatus which processes a broadcast signal of a broadcast program to display an image corresponding to the broadcast program, the method comprising:
receiving source data including predetermined broadcast information on the broadcast program;
determining extraction information corresponding to a format of the broadcast information included in the received source data among at least one extraction information to extract the broadcast information included in the source data; and
extracting the broadcast information included in the source data based on the determined extraction information.

13. The method according to claim 12, wherein the source data comprises a first web address, and the determining the extraction information comprises determining the extraction information corresponding to the first web address of the received source data, among at least one extraction in format ion.

14. The method according to claim 13, further comprising receiving the first web address, wherein
the receiving the source data comprises receiving the source data corresponding to the first web address.

15. The method according to claim 14, further comprising storing at least one second web address, wherein
the receiving the web address comprises selecting one of the at least one second web address and the selected web address corresponds to the first web address.

16. The method according to claim 12, wherein the determining the extraction information comprises receiving the at least one extraction information from an external device.

17. The method according to claim 12, further comprising generating a graphical user interface (GUI) to display the broadcast information extracted from the source data.

18. The method according to claim 17, wherein
the broadcast information comprises at least one of a channel, air time and content of the broadcast program, and
the generating the GUI comprises arranging the information on the channel, the air time and the content of the broadcast program to correspond to each other in the GUI.

19. The method according to claim 17, further comprising displaying the generated GUI.

20. The method according to claim 12, wherein the broadcast information extracted from the source data comprises extraction channel information on the channel, the method further comprising:
mapping between the extraction channel information and reception channel information on at least one channel of the received broadcast signal, and
receiving the broadcast signal of the corresponding channel if the valid extraction channel information is selected based on the mapping result.

21. The method according to claim 20, wherein the mapping between the extraction channel information and the reception channel information comprises determining the reception channel information corresponding to the extraction channel information by a user's input if the reception channel information equivalent to the extraction channel information does not exist.

22. The method according to claim 12, wherein the receiving the source data comprises receiving the source data by Bluetooth communication method.
